(19) United States
(12) Patent Application Publication
(10) Pub. No.: US 2021/0260702 A1
(43) Pub. Date: Aug. 26, 2021

(54) Method of laser processing hydrogen fuel cell plates

(71) Applicant: Laser Machining Inc. LMI AB, Nas (SE)

(72) Inventor: Timothy Hamblin-Smith, Nas (SE)

(21) Appl. No.: 17/181,353

(22) Filed: Feb. 22, 2021

Related U.S. Application Data
(60) Provisional application No. 62/979,222, filed on Feb. 20, 2020.

(51) Int. Cl. B23K 26/38; H01M 8/2475

(52) U.S. Cl. CPC B23K 26/38; B23K 2101/18; H01M 8/2475

(57) ABSTRACT

An apparatus and method for laser processing a stainless steel plate for use in a hydrogen fuel cell comprises securing the stainless steel plate on a fixture and providing a laser beam from a fiber laser sufficient to cut the stainless steel plate. A flow of pure nitrogen gas is provided to an area of the stainless steel plate being cut by the laser beam. Exit ports in the fixture for nitrogen gas to exit from the area being cut such that a sufficient flow of nitrogen is provided to remove laser ablations from the cutting area and to maintain a temperature at the cutting area not deleterious to the stainless steel plate being cut by the laser.

### CROSS-REFERENCE TO RELATED APPLICATION

The present application is based on and claims the benefit of U.S. provisional patent application Ser. No. 62/979,222, filed Feb. 20, 2020, the content of which is hereby incorporated by reference in its entirety.

### BACKGROUND

A hydrogen fuel cell is an electrochemical cell that reacts hydrogen with oxygen (air) to produce water and from this reaction produces electricity continuously as long as hydrogen and oxygen are supplied.

A typical hydrogen powered fuel cell is described in U.S. Pat. No. 6,989,214, the content of which is hereby incorporated by reference in its entirety. In brief, the fuel cell includes an anode plate and a cathode plate separated by a membrane. Hydrogen flows into contact with the anode plate where hydrogen is separated (ionized) into electrons and protons with the help of a catalyst. The electrons and protons flow through the membrane which is conductive. Due to the electron flow through the membrane a current is developed. The current produced is the resulting power output of the fuel cell. Oxygen typically in the form of air is introduced on the cathode side which then in turn reacts with the protons (hydrogen) to form water.

The flow of hydrogen through the anode plate and oxygen through the cathode plate is accomplished by flow channels that are created in the anode and the cathode plates. The single cell described above is repeated producing a stacked formation comprising a plurality of such cells which result in a fuel cell unit to achieve the desired electrical current outcome.

### SUMMARY

This disclosure describes a method for laser processing a stainless steel plate for use in a hydrogen fuel cell. The method comprises securing the stainless steel plate on a fixture and providing a laser beam from a fiber laser sufficient to cut the stainless steel plate. A flow of pure nitrogen gas is provided to an area of the stainless steel plate being cut by the laser beam. Exit ports in the fixture for nitrogen gas to exit from the area being cut such that a sufficient flow of nitrogen is provided to remove laser ablations from the cutting area and to maintain a temperature at the cutting area not deleterious to the stainless steel plate being cut by the laser.

In another aspect, the method includes the fiber laser being operated at a fixed frequency while the laser beam is being pulsed.

In another aspect, the laser beam is pulsed at a duty cycle duty cycle that is adjusted in relation to a real time cutting speed of the laser beam.

In another aspect, nitrogen is provided at approximately 20 to 21 bars.

In another embodiment of this disclosure, a fixture for retaining a stainless steel plate is part of a laser processing apparatus, the stainless steel plate for subsequent use in a hydrogen fuel cell, the fixture comprises a base for retaining the stainless steel plate sufficiently to be cut by a laser beam. The fixture retains the plate so that the plate is held sufficiently rigid to withstand a gas force of at least 20 bar. The base has at least one port, the port being flared in a direction away from the stainless steel plate being retained and the port is configured to permit sufficient gas to flow from an area retaining the plate as to not impede gas flow to the area retaining the plate.

In another aspect of this embodiment, the at least one port is positioned directly below the stainless steel plate.

In another aspect of this embodiment, the at least one port is positioned outside a cutting area of the laser beam.

In yet another embodiment of this disclosure, an apparatus for cutting channels or ports in a stainless steel plate for subsequent use in a hydrogen fuel cell includes a laser for producing a laser beam and a fixture for retaining the stainless steel plate during processing. The fixture comprises a base for retaining the stainless steel plate sufficiently to be cut by a laser beam so that the plate is held sufficiently rigid to withstand a gas force of at least 20 bar and wherein the base has at least one port, the port being flared in a direction away from the stainless steel plate being retained and the port being configured to permit sufficient gas to flow from an area retaining the plate as to not impede gas flow to the area retaining the plate.

In another aspect of this embodiment, the at least one port is positioned directly below the stainless steel plate.

In another aspect of this embodiment, the at least one port is positioned outside a cutting area of the laser beam.

### DRAWINGS

FIG. 1 is a perspective view of the method and apparatus of this disclosure.

FIG. 2 is perspective view of the fixture of this disclosure.

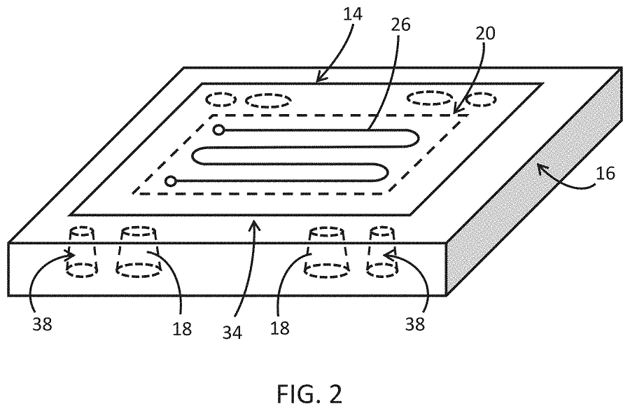

### DETAILED DESCRIPTION

The disclosure herein provides a method of producing flow channels and ports in metal plates which serve as anodes and cathode in fuel cells. The method utilizes a laser for cutting channels and ports to produce channels and ports with high accuracy, high speed and exceptionally high quality. The ports, once the fuel cell is assembled, are used as an entry point for hydrogen or oxygen into the channels and as an exit from the channels for the resulting reacted product. Producing channels and ports with high accuracy is required in order to provide a balanced flow of gas and coolant throughout the fuel cell unit to maintain performance.

Anode and cathode plates have to be produced sufficiently economically to achieve a fuel cell unit that is competitively priced for a market place such as to power vehicles. In an exemplary vehicle, 64 such metal plates may be required to produce one fuel cell unit.

Exceptional high quality is needed due to the way the hydrogen powered fuel cell converts chemical potential into electrical power. By high quality is meant to produce a fuel cell unit with as little if any contamination especially contamination from the cutting process. Contamination of the fuel cell plates is a primary service life restrictor. Any contamination will significantly reduce life expectancy of the fuel cell unit.

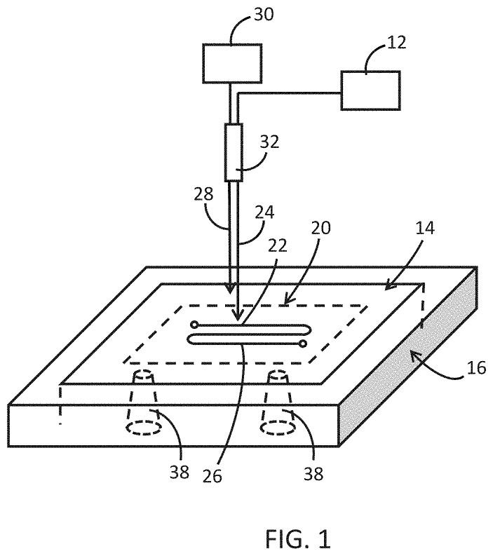

The cutting mechanism used to produce the channels and ports of the anode and cathode plates comprises a single mode fiber laser such as produced by IPG Photonics Corporation of Oxford Mass. as illustrated at 12 in FIG. 1. Fiber lasers have the ability to cut reflective metals such as stainless steel due to their inherent construction avoiding reflective bounce back of the laser beam.

For efficiency, the anode and cathode plates are formed directly upstream through a process described in one or more of the following U.S. Pat. Nos. 7,694,613; 7,368,075; 7,104,190; 6,821,471; 6,782,795 and US Published patent application 20170136522. For purposes of this application only one plate 14 will be shown and it should be understood that such plate represents both anode and cathode plates. Once the anode and cathode plates are formed, each are positioned individually on a metal fixture 16 and retained in place using vacuum cups 18. The vacuum cups 18 are positioned within the fixture 16 and outside of a cutting zone 20 depicted by broken lines. A typical plate made of stainless steel is approximately 0.1 mm (100 microns) thick and can be as thin as approximately 0.05 mm (50 microns) and approximately 0.5 by 11 inches in width and length. The plate is subjected to gas flow during the cutting as described further. Thus, the plate 14 has to be retained sufficiently in a fixed position due to the plate being so thin to withstand the gas flow and not flex during cutting in order to produce a precise cut. The plate 14 has to be kept in position at the cut 22 to a tolerance of about ±0.2 mm. Any deviation outside of this tolerance may lead to the production of molten material some of which may be loose and act as a contaminant during the operation of the fuel cell which would unduly limit the life of the fuel cell. Other methods of retaining the plates other than vacuum cups are contemplated as long as the attributes discussed herein are achieved. By cutting zone 20 is meant that area of the plate that is being processed by the laser beam 24. The suction cups 18 are positioned outside of the cutting zone 20 to avoid being damaged by the laser beam 24.

The fiber laser 12 is pulsed at a fixed frequency. The duty cycle of the laser beam is adjusted by pulsation of the beam. The duty cycle is a ratio of pulsing the laser beam on and off. For a fifty/fifty duty cycle, the beam is on fifty percent and off fifty percent. For a 90% duty cycle, the beam is on 90% and off 10%. The duty cycle is adjusted in relation to the real time cutting speed of the laser beam 24. As the cutting speed decreases, the duty cycle is reduced to achieve consistent power over cutting speed. Adjusting the duty cycle provides a consistent and high quality cut of the 0.1 mm thick stainless steel plate minimizing excessive ablations and loose molten material which as discussed becomes a contaminant in the operation of a fuel cell. The combination of high gas pressure use and adjusting the duty cycle in relation to the real time cutting speed of a single mode laser at a fixed frequency to cut 0.1 mm stainless steel plate is believed to be unique.

After the plate is secured and retained by the vacuum cups, the laser cuts predetermined channels and ports 26 in the plate as needed.

During laser cutting, a gas nozzle 28 directs pure nitrogen gas from a nitrogen gas source 30 at the cutting site and follows the focal point of the laser beam as it cuts the channels and ports 26. For simplicity of construction, the laser beam and the gas nozzle come are delivered through the same port 32. The nitrogen nozzle is positioned approximately 0.2 mm from the point of cutting (which is also approximately where the focal point of the laser beam is located). The nitrogen gas serves several purposes. The nitrogen gas is delivered at approximately 20 to 21 bars at the nozzle 32. One bar of pressure is approximately atmospheric pressure. Approximately 20 to 21 bars of pressure were empirically selected from experimentation as further explained. Although not specifically measured, it is believed that the gas pressure at the nozzle exit is approximately 11 to 12 bars initially at room temperature and increasing to approximately 22 bars at the point of cutting. It should be understood that the pressures identified herein are empirical in nature and are the result in part of the location of the nitrogen gas nozzle from the point of cutting, the flow of nitrogen and the resulting pressure from the flow and the heat buildup from the laser cutting the stainless steel. What is important is that that any molten stainless steel is carried away before it falls back, contacts and sticks to the plate being cut.

The flow of nitrogen gas at approximately 20 to 21 bars is sufficient to prevent molten steel produced by the laser cutting from settling on the cut or the plate 14 by carrying away the molten ablations. The nitrogen also serves to cool the surfaces being cut and the surfaces that have been cut such that the intended areas of the channels and ports 26 are precisely retained. In other words, the perimeter surfaces of the cut stay true during and after the cut and do not droop or waver due to the high temperature produced by the laser beam cutting the stainless steel. The flow of nitrogen at the selected pressure of approximately 20 to 21 bars is sufficient to prevent molten metal settling on the surface of the plate 14 including the cut without causing the thin stainless steel to flex in order to produce a precise cut.

The nitrogen gas is pure nitrogen gas in order to provide an inert atmosphere. An inert atmosphere is needed during cutting to avoid/minimize oxidation of the stainless steel during cutting.

A gas cushion 34 is formed beneath the secured plate 14 being cut due to the flow of nitrogen gas. The cushion 34 is a result of gas flowing through the channel/port cut being produced. Flared openings/ports 38 are provided in the fixture having a conical configuration which expands in diameter in the direction of the nitrogen outflow. The ports 38 are located directly under the cutting zone and sufficiently distanced from the point of cutting as to not be physically affected. The ports are provided as an exit for the nitrogen gas. The nitrogen gas becomes heated as it flows to cool the cut metal and metal being cut and expands in volume as the temperature of the nitrogen gas rises. The nitrogen gas expansion becomes a resistive force to the incoming nitrogen gas such that the out flow of nitrogen needs to be regulated so that it does not obstruct the inflow of nitrogen and does not affect the cooling effect of the nitrogen. In one example the flared openings were 5 mm wide at the surface expanding to 20 mm wide at the exhaust end which was found to be sufficient for the particular situation.

Thus the size and number of the ports 38 used to exit nitrogen gas were empirically determined based on the flow and temperature of nitrogen gas needed to cool the cutting areas and remove the steel ablations.

What is claimed is:

1. A method for laser processing a stainless steel plate for use in a hydrogen fuel cell, the method comprising:
securing the stainless steel plate on a fixture;
providing a laser beam from a fiber laser sufficient to cut the stainless steel plate;
providing a flow of pure nitrogen gas to an area of the stainless steel plate being cut by the laser beam;
providing exit ports for nitrogen gas to exit from the area being cut such that a sufficient flow of nitrogen is provided to remove laser ablations from the cutting area and to maintain a temperature at the cutting area not deleterious to the stainless steel plate being cut by the laser.

2. The method of claim 1 wherein the fiber laser is operated at a fixed frequency while the laser beam is pulsed.

3. The method of claim 2 where the laser beam is pulsed at a duty cycle duty cycle that is adjusted in relation to a real time cutting speed of the laser beam.

4. The method of claim 1 wherein the nitrogen is provided at approximately 20 to 21 bars.

5. A fixture for retaining a stainless steel plate, the fixture being part of a laser processing apparatus, the stainless steel plate for subsequent use in a hydrogen fuel cell, the fixture comprising:
a base for retaining the stainless steel plate sufficiently to be cut by a laser beam, the fixture retaining the plate so that the plate is held sufficiently rigid to withstand a gas force of at least 20 bar;
wherein the base has at least one port, the port being flared in a direction away from the stainless steel plate being retained and the port being configured to permit sufficient gas to flow from an area retaining the plate as to not impede gas flow to the area retaining the plate.

6. The fixture of claim 5 wherein the at least one port is positioned directly below the stainless steel plate.

7. The fixture of claim 6 wherein the at least one port is positioned outside a cutting area of the laser beam.

8. An apparatus for cutting channels or ports in a stainless steel plate for subsequent use in a hydrogen fuel cell, the apparatus including a laser for producing a laser beam and fixture for retaining the stainless steel plate during processing, the fixture comprising:
a base for retaining the stainless steel plate sufficiently to be cut by a laser beam, the fixture retaining the plate so that the plate is held sufficiently rigid to withstand a gas force of at least 20 bar; and
wherein the base has at least one port, the port being flared in a direction away from the stainless steel plate being retained and the port being configured to permit sufficient gas to flow from an area retaining the plate as to not impede gas flow to the area retaining the plate.

9. The fixture of claim 8 wherein the at least one port is positioned directly below the stainless steel plate.

10. The fixture of claim 9 wherein the at least one port is positioned outside a cutting area of the laser beam.
